(19) United States
(12) Patent Application Publication
(10) Pub. No.: US 2023/0406755 A1
(43) Pub. Date: Dec. 21, 2023

(54) PLASMA-RESISTANT GLASS AND MANUFACTURING METHOD THEREFOR

(71) Applicants: IONES CO., LTD., Gyeonggi-do (KR); KOREA INSTITUTE OF CERAMIC ENGINEERING AND TECHNOLOGY, Gyeongsangnam-do (KR)

(72) Inventors: Dae Gean KIM, Gyeonggi-do (KR); Hye Won SEOK, Seoul (KR); Hyeong Jun KIM, Chungcheongnam-do (KR)

(21) Appl. No.: 18/248,312

(22) PCT Filed: Oct. 5, 2021
(86) PCT No.: PCT/KR2021/013593

§ 371 Date: Apr. 7, 2023

(30) Foreign Application Priority Data
Oct. 8, 2020 (KR) 10-2020-0130481
May 31, 2021 (KR) 10-2021-0070398

(51) Int. Cl. C03C 3/112

(52) U.S. Cl. CPC C03C 3/112; C03C 2203/10

(57) ABSTRACT

An embodiment of the present invention relates to a plasma-resistant glass, and a manufacturing method therefor, and the present invention is intended to provide a plasma-resistant glass having improved plasma resistance properties, and a manufacturing method therefor. To this end, the present invention provides a plasma-resistant glass including SiO₂ in an amount of 40 to 75 mol %, Al₂O₃ in an amount of 5 to 20 mol %, MgO in an amount of 10 to 40 mol %, and MgF₂ in an amount of 0.01 to 10 mol %, and a manufacturing method therefor.

### TECHNICAL FIELD

The present invention relates to a plasma-resistant glass and a manufacturing method therefor.

### BACKGROUND ART

When manufacturing semiconductors and/or displays, a plasma etching process is applied. As nano processes are recently applied, etching difficulty is increased, and as interior components of a process chamber exposed to a high-density plasma environment, oxide-based ceramics such as alumina (Al₂O₃) and yttria (Y₂O₃) which have corrosion resistance are mainly used.

When a polycrystalline material is exposed to a high-density plasma etching environment in which a fluorine-based gas is used for a long period of time, particles are detached due to local erosion, thereby increasing the chances of generating contaminant particles. This causes defects in semiconductors/displays and adversely affects production yield.

The description disclosed in the Background section is only for a better understanding of the background of the invention and may also include information which does not constitute the related art.

### DETAILED DESCRIPTION OF THE INVENTION

### Technical Problem

The present invention provides a plasma-resistant glass having improved plasma resistance properties, and a manufacturing method therefor.

### Technical Solution

A method for manufacturing a plasma-resistant glass according to an embodiment of the present invention may include mixing SiO₂ powder, Al₂O₃ powder, MgO powder, and MgF₂ powder to prepare a plasma-resistant glass raw material, melting the plasma-resistant glass raw material, slowly cooling the molten product at a temperature higher than a glass transition temperature (T_{g}), furnace-cooling the slowly cooled product to room temperature, and obtaining a furnace-cooled plasma-resistant glass, wherein the obtained plasma-resistant glass may include SiO₂ in an amount of 40 to 75 mol %, Al₂O₃ in an amount of 5 to 20 mol %, MgO in an amount of 10 to 40 mol %, and MgF₂ in an amount of 0.01 to 10 mol %.

A molar ratio of the MgO and the MgF₂ may be 90:10 to 80:20.

The obtained plasma-resistant glass may have a glass transition temperature (T_{g}) of 700° C. to 800° C.

The obtained plasma-resistant glass may have a softening point (T_{dsp}) of 750° C. to 850° C.

The obtained plasma-resistant glass may be a glass used in a mixed plasma environment of fluorine and argon (Ar), and the obtained plasma-resistant glass may have plasma resistance properties with an etching rate of 15 nm/min or lower for a mixed plasma of fluorine and argon.

The melting may be performed at a temperature of 1300° C. to 1650° C.

The slow cooling may be performed at a temperature of 700° C. to 900° C.

A plasma-resistant glass according to an embodiment of the present invention may include SiO₂ in an amount of 40 to 75 mol %, Al₂O₃ in an amount of 5 to 20 mol %, MgO in an amount of 10 to 40 mol %, and MgF₂ in an amount of 0.01 to 10 mol %.

The plasma-resistant glass may be an interior component of a process chamber for semiconductor manufacturing.

The interior component may be any one of a focus ring, an edge ring, a cover ring, a ring shower, an insulator, an EPD window, an electrode, and a view port, an inner shutter, an electro static chuck, a heater, a chamber liner, a shower head, a boat for chemical vapor deposition (CVD), a wall liner, a shield, a cold pad, a source head, an outer liner, a deposition shield, an upper liner, an exhaust plate, and a mask frame.

### ADVANTAGEOUS EFFECTS

An embodiment of the present invention provides a plasma-resistant glass having improved plasma resistance properties, and a manufacturing method therefor. For example, the plasma-resistant glass according to an embodiment of the present invention may be a glass used in a mixed plasma environment of fluorine and argon (Ar), and in this case, the plasma-resistant glass has an etching rate of about 15 nm/min or lower for a mixed plasma of fluorine and argon. In addition, the plasma-resistant glass according to an embodiment of the present invention has a hardness (Gpa) of about 6.5 to about 7.5, a dielectric constant (F/m) of about 4 to about 6, and a density (g/cm³) of about 2 to about 3, and may thus be suitably used in typical plasma etching equipment.

### BRIEF DESCRIPTION OF THE DRAWINGS

FIG. 1 is a flowchart showing a method for manufacturing a plasma-resistant glass according to an embodiment of the present invention.

FIG. 2 is a table showing a composition ratio for manufacturing a plasma-resistant glass according to an embodiment of the present invention.

FIG. 3 is an image showing a plasma-resistant glass according to an embodiment of the present invention.

FIG. 4 is a table showing various properties of a plasma-resistant glass according to an embodiment of the present invention.

FIG. 5 is a graph showing results of measuring amorphous patterns for a plasma-resistant glass according to an embodiment of the present invention.

### MODE FOR CARRYING OUT THE INVENTION

Hereinafter, preferred embodiments will now be described in detail with reference to the accompanying drawings.

Embodiments of the present invention are provided to describe the present invention more completely understandable to those skilled in the art, and the following embodiments may be modified in various forms and the scope of the present invention is limited to the embodiments described below. Rather, these embodiments are provided so that this disclosure will be thorough and complete, and will fully convey the inventive concept to one of ordinary skill in the art.

As used herein, the term “and/or” includes any and all combinations of one or more of the associated listed items. In addition, terms used herein are to describe particular embodiments and do not limit the present invention. As used herein, singular forms are intended to include plural forms as well, unless the context clearly indicates otherwise. In addition, it will be further understood that the terms “comprises” and/or “comprising” used herein specify the presence of stated shapes, numbers, steps, operations, components, elements, and/or a group thereof, but do not preclude the presence or addition of one or more other shapes, numbers, steps, operations, components, elements, and/or groups thereof.

It will be understood that although the terms “first”, “second”, and the like may be used herein to describe various elements, components, regions, layers, and/or portions, these elements, components, regions, layers, and/or portions should not be limited by these terms. The terms do not indicate a particular member, component, region, layer, or portion, but are only used to distinguish one from another. Accordingly, a first member, component, region, or portion that will be described below may indicate a second member, component, region, or portion without deviating from teachings of the present invention.

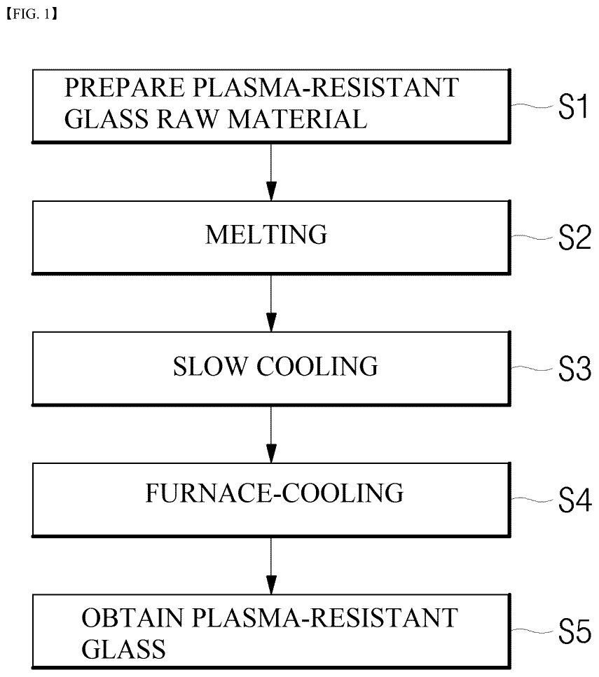

Referring to FIG. 1, a flowchart on a method for manufacturing a plasma-resistant glass according to an embodiment of the present invention is shown.

As shown in FIG. 1, the method for manufacturing a plasma-resistant glass according to an embodiment of the present invention may include preparing a plasma-resistant glass raw material (S1), melting (S2), slow cooling (S3), furnace-cooling (S4), and obtaining a plasma-resistant glass (S5).

In the preparing of a plasma-resistant glass raw material (S1), SiO₂ powder, Al₂O₃ powder, MgO powder, and MgF₂ powder may be mixed to prepare a plasma-resistant glass raw material.

In some examples, Al₂O₃ may include, for example, Al(OH)₃ as a precursor, MgO may include, for example, Mg(OH)₂ as a precursor, and MgF₂ may include, for example, a solution formed through a reaction between of MgCl₂ and anhydrous HF as a precursor.

In the melting (S2), the plasma-resistant glass raw material may be melted.

In some examples, the melting may be performed at a temperature of about 1300° C. to about 1650° C. in an oxidizing atmosphere.

In the slow cooling (S3), the molten plasma-resistant glass raw material may be slowly cooled or annealed.

In some examples, the slow cooling or annealing may be performed at a temperature of about 700° C. to about 900° C. in an oxidizing atmosphere.

In the furnace-cooling (S4), the slow cooled plasma-resistant glass raw material may be gradually cooled.

In some examples, the furnace-cooling may be performed by allowing the temperature in the furnace to naturally reach room temperature (e.g., 20° C.).

In the obtaining of a plasma-resistant glass (S5), a furnace-cooled product, that is, a plasma-resistant glass manufactured according to an embodiment of the present invention may be obtained.

In some examples, the obtained plasma-resistant glass may have a glass transition temperature (T_{g}) of about 700° C. to about 800° C.

In some examples, the obtained plasma-resistant glass may have a softening point (T_{dsp}) of about 700° C. to about 800° C.

In some examples, the obtained plasma-resistant glass may include SiO₂ in an amount of about 40 mol % to about 75 mol %, Al₂O₃ in an amount of about 5 mol % to about 20 mol %, MgO in an amount of about 10 mol % to about 40 mol %, and MgF₂ in an amount of about 0.01 mol % to about 10 mol %.

In some examples, a molar ratio of MgO and MgF₂ in the obtained plasma-resistant glass may be 90:10 to 80:20.

In some examples, the obtained plasma-resistant glass may be a glass used in a mixed plasma environment of fluorine and argon (Ar), and the obtained plasma-resistant glass may have plasma resistance properties with an etching rate of about 5 nm/min to about 15 nm/min for a mixed plasma of fluorine and argon.

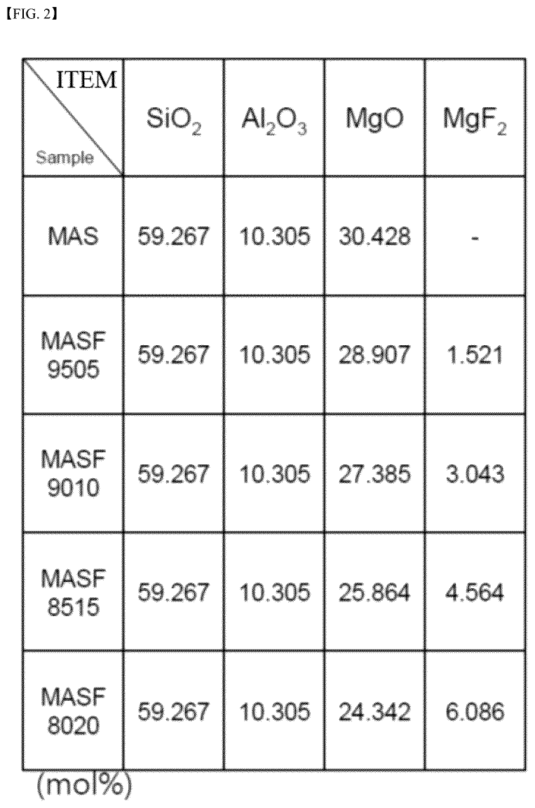

Referring to FIG. 2, a table on a composition ratio for manufacturing a plasma-resistant glass according to an embodiment of the present invention is shown.

### Example 1 (MASF 9505)

In the preparing of a plasma-resistant glass material (S1), SiO₂ powder in an amount of 59.267 mol %, Al₂O₃ powder in an amount of 10.305 mol %, MgO powder in an amount of 28.907 mol %, and MgF₂ powder in an amount of 1.521 mol % were mixed to prepare a plasma-resistant glass material.

As an example, a total amount of chemical components was set in a weight of 600 g, and the plasma-resistant glass raw material was mixed for about 1 hour using a zirconia ball milling method. In some examples, the plasma-resistant glass material was dry mixed with 600 g of material:1800 g of zirconia ball (a weight ratio of 1:3), and then dried for 24 hours. As another example, a total amount of chemical components was set in a weight of 600 g, and the plasma-resistant glass raw material may be mixed for about 1 hour using a zirconia ball milling method. In some examples, the plasma-resistant glass material may be wet mixed with 600 g of raw material:2400 g of ethanol:5400 g of zirconia ball (a weight ratio 1:4:9), and then dried for 24 hours.

In the melting (S2), the temperature was raised at a rate of 10° C/min until the plasma-resistant glass raw material mixed through a dry mixing method or a wet mixing method reached 1400° C. using a super-kanthal furnace, and the plasma-resistant glass raw material was kept at 1400° C. about 2 hours and 30 minutes.

In the slow cooling (S3), the molten plasma-resistant glass was slowly cooled until the molten plasma-resistant glass reached 820° C., and kept at 820° C. for about 3 hours.

In the furnace-cooling (S4), the slowly cooled plasma-resistant glass was naturally cooled until the slowly cooled plasma-resistant glass reached room temperature (e.g., 20° C.).

Then, in the obtaining of a plasma-resistant glass (S5), a furnace-cooled plasma-resistant glass including MgO and MgF₂ was obtained. In this case, a molar ratio of MgO and MgF₂ may be about 95:5.

### Example 2 (MASF9010)

In the preparing of a plasma-resistant glass raw material (S1), SiO₂ powder in an amount of 59.267 mol %, Al₂O₃ powder in an amount of 10.305 mol %, MgO powder in an amount of 27.385 mol %, and MgF₂ powder in an amount of 3.043 mol % were mixed to prepare a plasma-resistant glass material. Other steps S2 to S5 are similar or the same as in Example 1. In this case, a molar ratio of MgO and MgF₂ in the obtained plasma-resistant glass may be about 90:10.

### Example 3 (MASF8515)

In the preparing of a plasma-resistant glass raw material (S1), SiO₂ powder in an amount of 59.267 mol %, Al₂O₃ powder in an amount of 10.305 mol %, MgO powder in an amount of 25.864 mol %, and MgF₂ powder in an amount of 4.564 mol % were mixed to prepare a plasma-resistant glass material. Other steps S2 to S5 are similar or the same as in Example 1. In this case, a molar ratio of MgO and MgF₂ in the obtained plasma-resistant glass may be about 85:15.

### Example 4 (MASF8020)

In the preparing of a plasma-resistant glass raw material (S1), SiO₂ powder in an amount of 59.267 mol %, Al₂O₃ powder in an amount of 10.305 mol %, MgO powder in an amount of 24.342 mol %, and MgF₂ powder in an amount of 6.086 mol % were mixed to prepare a plasma-resistant glass material. Other steps S2 to S5 are similar or the same as in Example 1. In this case, a molar ratio of MgO and MgF₂ in the obtained plasma-resistant glass may be about 80:20.

### Comparative Example (MAS)

In the preparing of a plasma-resistant glass raw material (S1), SiO₂ powder in an amount of 59.267 mol %, Al₂O in an amount of 10.305 mol %, and MgO powder in an amount of 30.428 mol % were mixed to prepare a plasma-resistant glass material. Other steps S2 to S5 are similar or the same as in Example 1. In this case, MgF₂ is not present in the obtained plasma-resistant glass.

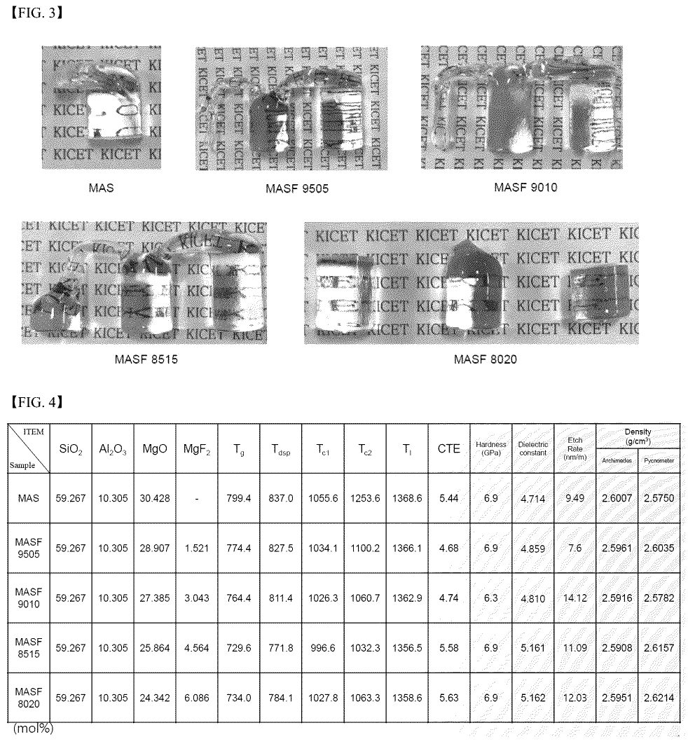

Referring to FIG. 3, an image of a plasma-resistant glass according to an embodiment of the present invention is shown. In this case, MAS, MASF9505, MASF9010, MASF8515, and MASF 8020 are images of plasma-resistant glasses prepared according to Comparative Example, Example 1, Example 2, Example 3, and Example 4, respectively. As shown in FIG. 3, the plasma-resistant glasses according to Comparative Example and Examples 1 to 4 were all transparent and did not have a specific color (e.g., yellow or white).

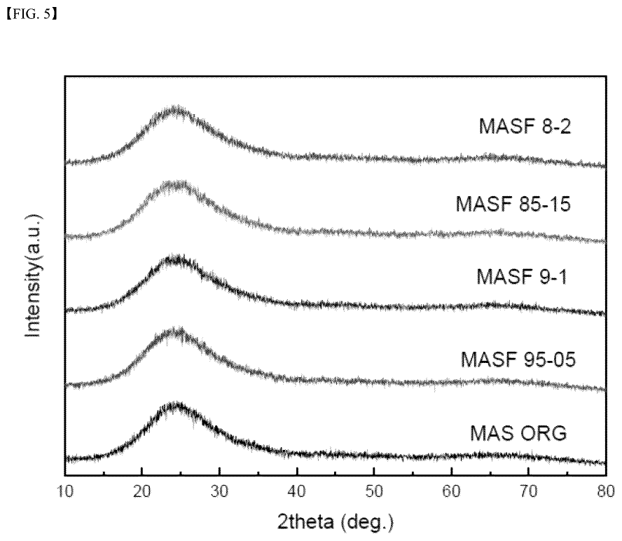

Referring to FIG. 4, a table on various properties of a plasma-resistant glass according to an embodiment of the present invention is shown.

First, thermal properties (T_{g}, T_{c1,C2} and T₁) of the plasma-resistant glass were measured. The completed plasma-resistant glass was placed in Labsys evo, and then the temperature was raised to 1400° C. at a rate of 10° C./min, and in this case, an argon gas (40˜50 cc/min) was used.

The plasma-resistant glass prepared by Example 1 (MASF9505) was measured to have a glass transition temperature (T_{g}) of about 774.4° C., a first inflection point temperature (T_{c1}) of about 1034.1° C., a second inflection point temperature (T_{c2}) of about 1100.2° C., and a liquidus temperature (T₁) of 1366.1° C.

The plasma-resistant glass prepared by Example 2 (MASF9010) was measured to have a glass transition temperature (T_{g}) of about 764.4° C., a first inflection point temperature (T_{c1}) of about 1026.3° C., a second inflection point temperature (T_{c2}) of about 1060.7° C., and a liquidus temperature (T₁) of 1362.9° C.

The plasma-resistant glass prepared by Example 3 (MASF8515) was measured to have a glass transition temperature (T_{g}) of about 729.6° C., a first inflection point temperature (T_{c1}) of about 996.6° C., a second inflection point temperature (T_{c2}) of about 1030.3° C., and a liquidus temperature (T₁) of 1356.5° C.

The plasma-resistant glass prepared by Example 4 (MASF8020) was measured to have a glass transition temperature (T_{g}) of about 734.0° C., a first inflection point temperature (T_{c1}) of about 1027.8° C., a second inflection point temperature (T_{c2}) of about 1063.3° C., and a liquidus temperature (T₁) of 1358.6° C.

The plasma-resistant glass prepared by Comparative Example (MAS) was measured to have a glass transition temperature (T_{g}) of about 799.4° C., a first inflection point temperature (T_{c1}) of about 1056.6° C., a second inflection point temperature (T_{c2}) of about 1253.6° C., and a liquidus temperature (T₁) of 1368.6° C.

As a result, T_{g}, T_{c1,C2}, and T₁ generally decreased as the amount of MgF₂ increased, but T_{g}, T_{c1,C2}, and T₁ increased again when a ratio of MgO and MgF₂ was about 80:20.

Thereafter, thermal expansion coefficient (CTE:×10⁻⁶ m/(m° C.)), glass transition temperature (T_{g}), and softening point (T_{dsp}) of the plasma-resistant glass were measured. The completed plasma-resistant glass was placed in Labsys evo, and then the temperature was raised to 1000° C. at a rate of 10° C/min, and in this case, gas was not used.

The plasma-resistant glass prepared by Example 1 (MASF9505) was measured to have a CTE of about 4.68, a glass transition temperature (T_{g}) of about 774.4° C., and a softening point (Tdsp) of about 827.5° C.

The plasma-resistant glass prepared by Example 2 (MASF9010) was measured to have a CTE of about 4.74, a glass transition temperature (T_{g}) of about 764.4° C., and a softening point (T_{dsp}) of about 811.4° C.

The plasma-resistant glass prepared by Example 3 (MASF8515) was measured to have a CTE of about 5.58, a glass transition temperature (T_{g}) of about 729.6° C., and a softening point (T_{dsp}) of about 771.8° C.

The plasma-resistant glass prepared by Example 4 (MASF8020) was measured to have a CTE of about 5.63, a glass transition temperature (T_{g}) of about 734.0° C., and a softening point (T_{dsp}) of about 784.1° C.

The plasma-resistant glass prepared by Comparative Example (MAS) was measured to have a CTE of about 5.44, a glass transition temperature (T_{g}) of about 799.4° C., and a softening point (T_{dsp}) of about 837.0° C.

As a result, CTE, T_{dsp}, and T_{g} generally decreased as the amount of MgF₂ increased, but CTE, T_{dsp}, and T_{g} increased again above a certain value.

Thereafter, hardness (GPa) of the plasma-resistant glass was measured. The completed plasma-resistant glass was placed on HMV and a micro hardness tester (SHIMADZU), and then was measured 5 times with a force of 300 g.f (2.94199 N) to obtain an average value.

The completed plasma-resistant glass was measured to have a hardness (GPa) of about 6.9 for Example 1 (MASF9505), about 6.3 for Example 2 (MASF9010), about 6.9 for Example 3, and about 6.9 for Example 4, and about 6.9 for Comparative Example (MAS).

As a result, there was generally no change in hardness with an increase in an amount of MgF₂. For reference, a hardness of quartz is about 20, a hardness of synthetic quartz is about 8.23, a hardness of sapphire is about 17.9, and a hardness of an Al₂O₃ coating layer is about 17.1.

Then, dielectric constant (F/m) of the plasma-resistant glass was measured. It was measured for 1 minute at a frequency of 1 MHz, and was measured 5 times to obtain an average value.

The completed plasma-resistant glass was measured to have a dielectric constant (F/m) of about 4.859 for Example 1 (MASF9505), about 4.810 for Example 2 (MASF9010), about 5.161 for Example 3, and about 5.162 for Example 4, and about 4.714 for Comparative Example (MAS).

As a result, the dielectric constant value generally increased as the amount of MgF₂ increased.

Thereafter, etching rate (nm/min) of plasma-resistant glass was measured. The completed plasma-resistant glass was placed on a surfcorder ET3000 (Kosaka laboratory Ltd., Japan), and then measure 3 times to obtain an average value. In this case, the etching conditions were as follows.
RF power(W): 600
RF power, bias(W): 150
CF₄(SCCM): 30
Ar(SCCM): 10
O2(SCCM): 5
Pressure(mTorr): 10
Time(min): 60

The plasma-resistant glass was measured to have an etching rate (nm/min) of about 7.6 for Example 1 (MASF9505), about 14.12 for Example 2 (MASF9010), about 11.09 for Example 3, and about 12.03 for Example 4, and about 9.49 for Comparative Example (MAS).

As a result, the etching rate generally decreased as the amount of MgF₂ increased, but in Example 1 (MASF9505), the etching rate was particularly decreased. For reference, an etching rate of sapphire is about 29.37, an etching rate of quartz is about 214.01, and an etching rate of synthetic quartz is about 212.49.

Thereafter, density (g/cm³) of the plasma-resistant glass was measured. The density of the completed plasma-resistant glass was measured by Archimedes/Pycnometer.

The plasma-resistant glass was measured to have a density (g/cm³) of about 2.59 for Example 1 (MASF9505), about 2.59 for Example 2 (MASF9010), about 2.59 for Example 3 (MASF8515), and about 2.59 for Example 4 (MASF8020), and about 2.6 for Comparative Example (MAS).

As a result, the density was generally similar regardless of an increase in the amount of MgF₂.

Referring to FIG. 5, a graph on results of measuring amorphous patterns for the plasma-resistant glass according to an embodiment of the present invention is shown. In FIG. 5, the X axis is 2θ (deg.), the Y-axis is intensity (a.u.), and a crystal structure of the plasma-resistant glasses prepared according to Examples and Comparative Examples of the present invention was measured at a rate of 10°/min between about 10° and 80° by X-ray diffraction (XRD) equipment. As shown in FIG. 5, the plasma-resistant glasses prepared according to Examples 1 to 4 and Comparative Example had a peak value of 2 theta between 20° and 30°, indicating that the plasma-resistant glasses did not have a specific crystal structure, that is, an amorphous structure.

As a result, it is seen that when the plasma-resistant glass includes MgF₂, the glass transition temperature (T_{g}) and the softening point (T_{dsp}) are lowered. Therefore, the plasma-resistant glass including MgF₂ has reduced viscosity and melting point, and accordingly, a plasma-resistant glass having a low melting point, which is easy to process is eventually provided.

In addition, when the plasma-resistant glass includes MgF₂, plasma resistance properties are improved. For example, when the plasma-resistant glass is exposed to a CF₄-based plasma environment, a fluorine compound layer is formed on the plasma-resistant glass through an inter-reaction. Such a fluorine compound layer reduces the etching rate. However, in an embodiment of the present invention, the plasma-resistant glass already includes a fluorine (F) element, and accordingly, when the plasma-resistant glass is exposed to a CF₄-based plasma environment, a fluorine compound layer is formed to be thicker more quickly on a surface of the plasma-resistant glass, and the plasma resistance properties may thus be further improved. In this case, when MgO and MgF₂ have a molar ratio of a predetermined ratio (e.g., 90:10 to 80:20), the plasma resistance properties may be further improved.

In addition, the plasma-resistant glass including MgO and MgF₂ has values of hardness, dielectric constant, and density, which match existing components within plasma etching equipment without any heterogeneity, and may thus be easily adopted in existing plasma etching equipment.

For example, the above-described plasma-resistant glass may be an interior component of a process chamber for manufacturing semiconductors or displays. For example, the interior component may include a focus ring, an edge ring, a cover ring, a ring shower, an insulator, an EPD window, an electrode, and a view port, an inner shutter, an electro static chuck, a heater, a chamber liner, a shower head, a boat for chemical vapor deposition (CVD), a wall liner, a shield, a cold pad, a source head, an outer liner, a deposition shield, an upper liner, an exhaust plate, and/or a mask frame. In this case, the above-described interior components may be manufactured through various methods such as melting, compression molding, or compression sintering of the above-described plasma-resistant glass powder.

The above description is merely an embodiment for implementing a plasma-resistant glass according to the present invention and performing a method for manufacturing the same, so that the present invention is not limited thereto. The true scope of the present invention should be defined to the extent that those skilled in the art may make various modifications and changes thereto without departing from the scope of the invention, as defined by the appended claims.

1. A method for manufacturing a plasma-resistant glass, the method comprising:
mixing SiO₂ powder, Al₂O₃ powder, MgO powder, and MgF₂ powder to prepare a plasma-resistant glass raw material;
melting the plasma-resistant glass raw material;
slowly cooling the molten product at a temperature higher than a glass transition temperature (T_{g});
furnace-cooling the slowly cooled product to room temperature; and
obtaining a furnace-cooled plasma-resistant glass,
wherein the obtained plasma-resistant glass comprises SiO₂ in an amount of 40 to 75 mol %, Al₂O₃ in an amount of 5 to 20 mol %, MgO in an amount of 10 to 40 mol %, and MgF₂ in an amount of 0.01 to 10 mol %.

2. The method of claim 1, wherein a molar ratio of the MgO and the MgF₂ is 90:10 to 80:20.

3. The method of claim 1, wherein the obtained plasma-resistant glass has a glass transition temperature (T_{g}) of 700° C. to 800° C.

4. The method of claim 1, wherein the obtained plasma-resistant glass has a softening point (T_{dsp}) of 750° C. to 850° C.

5. The method of claim 1, wherein the obtained plasma-resistant glass is a glass used in a mixed plasma environment of fluorine and argon (Ar), and the obtained plasma-resistant glass has plasma resistance properties with an etching rate of 15 nm/min or lower for a mixed plasma of fluorine and argon.

6. The method of claim 1, wherein the melting is performed at a temperature of 1300° C. to 1650° C.

7. The method of claim 1, wherein the slow cooling is performed at a temperature of 700° C. to 900° C.

8. A plasma-resistant glass comprising SiO₂ in an amount of 40 to 75 mol %, Al₂O₃ in an amount of 5 to 20 mol %, MgO in an amount of 10 to 40 mol %, and MgF₂ in an amount of 0.01 to 10 mol %.

9. The plasma-resistant glass of claim 8, wherein a molar ratio of the MgO and the MgF₂ is 90:10 to 80:20.

10. The plasma-resistant glass of claim 8, wherein the plasma-resistant glass has a glass transition temperature (T_{g}) of 700° C. to 800° C.

11. The plasma-resistant glass of claim 8, wherein the plasma-resistant glass has a softening point (T_{dsp}) of 750° C. to 850° C.

12. The plasma-resistant glass of claim 8, wherein the plasma-resistant glass is a glass used in a mixed plasma environment of fluorine and argon (Ar), and the plasma-resistant glass has plasma resistance properties with an etching rate of 15 nm/min or lower for a mixed plasma of fluorine and argon.

13. The plasma-resistant glass of claim 8, wherein the plasma-resistant glass is an interior component of a process chamber for semiconductor manufacturing.

14. The plasma-resistant glass of claim 13, wherein the interior component is any one of a focus ring, an edge ring, a cover ring, a ring shower, an insulator, an EPD window, an electrode, and a view port, an inner shutter, an electro static chuck, a heater, a chamber liner, a shower head, a boat for chemical vapor deposition (CVD), a wall liner, a shield, a cold pad, a source head, an outer liner, a deposition shield, an upper liner, an exhaust plate, and a mask frame.
